(19) United States
(12) Patent Application Publication
(10) Pub. No.: US 2025/0034470 A1
(43) Pub. Date: Jan. 30, 2025

(54) DIALKYL PHENOL INITIATED POLYETHERAMINE AND USES THEREOF

(71) Applicant: HUNTSMAN PETROCHEMICAL LLC, The Woodlands, TX (US)

(72) Inventors: Haibo ZHAO, The Woodlands, TX (US); Yusheng GAO, Shanghai (CN)

(21) Appl. No.: 18/716,186

(22) PCT Filed: Dec. 7, 2022
(86) PCT No.: PCT/US2022/052081

§ 371 Date: Jun. 4, 2024

Related U.S. Application Data
(60) Provisional application No. 63/287,995, filed on Dec. 10, 2021.

(51) Int. Cl. C10L 10/04; C08G 65/26; C08G 65/325; C10L 1/06

(52) U.S. Cl. CPC C10L 10/04; C08G 65/2612; C08G 65/3255; C10L 1/06; C10L 2200/0259; C10L 2230/22; C10L 2270/023

(57) ABSTRACT

A polyetheramine produced from a dialkyl phenol initiator which is first alkoxylated with propylene oxide and then reductively aminated to form the polyetheramine. The polyetheramine may be used in a variety of applications, such as a fuel additive in a fuel composition.

### CROSS REFERENCE TO RELATED APPLICATIONS

This application claims priority to U.S. Provisional Patent Application Ser. No. 63/287,995 filed Dec. 10, 2021. The noted application is incorporated herein by reference.

### FIELD

The present disclosure is generally directed to a dialkyl phenol initialized polyetheramine and its use in various applications, including, but not limited to, as a fuel additive in a fuel composition for reducing and preventing deposits in an engine.

### BACKGROUND

It is generally known that deposits can form on the surfaces of various engine components (for e.g., carburetor ports, throttle valves, fuel injectors, intake ports, and intake valves) during the operation of the engine due to the oxidation and polymerization of hydrocarbons. It is also known that deposits can form in the combustion chamber due to the incomplete combustion of the air, fuel and oil mixture. These deposits, even when present in relatively small amounts, can cause significant driving problems such as stalling and poor acceleration. In addition, these deposits can significantly increase the fuel consumption of the vehicle and the production of exhaust pollutants.

Recently, vehicles fueled by electronic control devices have gradually replaced vehicles fueled through carburetors. When an automobile has its fuel supply controlled by an electronic device, the fuel injector in the engine will have a small aperture, a high working temperature and poor fuel lubricity and therefore can be easily blocked by deposits causing various problems, for example, poor atomization, unsmooth fuel supply, fuel waste, substandard emission and the like. After long-term use, deposits will also form on the sealing surface of the air inlet valve of the electronic injection engine causing the cylinder to not seal tightly, the power of the engine to be reduced and non-combustible gas to leak out. This seriously affects fuel economy, power output of the engine, and the quality of exhaust gas that is emitted thus degrading the performance of the engine.

One common approach to address the problems discussed above is to add a fuel additive to the fuel prior to its combustion. One type of fuel additive generally used is a hydrocarbyl-substituted amine such as polyisobutyl amine. This type of fuel additive has an excellent cleaning effect on the fuel nozzle and the air intake valve in a gasoline engine and can inhibit and effectively clean deposits on these parts of the engine. However, using this type of fuel additive can cause deposits purged from the fuel intake system to be carried into the combustion chamber causing a significant increase in deposits therein.

Another type of fuel additive used is a polyetheramine. Typically, polyetheramines are single component additives in which both amine functionality and polyether functionality are present in the same molecule. It is generally recognized in the art that polyetheramine-based fuel additives are preferred since they may reduce: the production of particulate matter; nitrogen oxide (NOₓ) emissions; and combustion chamber deposits.

Examples of state of the art polyetheramines can be found in U.S. Pat. Nos. 4,191,537, 4,261,704, 5,752,991, 4,985,047, 5,112,364, 4,609,377, 6,372,000, 6,217,624, 6,548,461, 4,747,851, 5,527,364, 5,660,601, 6,224,642, and 6,548,461. These polyetheramines are initialized by alcohols (linear or branched) or mono-alkyl phenols and it is disclosed their performance as an effective fuel additive will increase as the butylene oxide content in the polyether backbone is increased. However, increasing the butylene oxide content also significantly increases the cost of the resulting polyetheramine.

Accordingly, there is a continued need to develop new, cost effective polyetheramine fuel additives which are able to provide similar or improved performance as that for state of the art polyetheramines having a high butylene oxide content.

### SUMMARY

The present disclosure describes a fuel additive for a fuel comprising a polyetheramine compound having a formula (1)

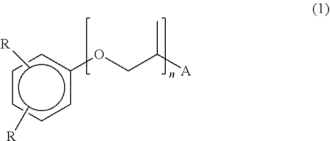

where each R may be the same or different and is an alkyl group having up to 30 carbon atoms, n is an integer from about 2 to about 200, and A is —NH₂ or —NHRₐ, where Rₐ is an alkyl group having up to about 30 carbon atoms.

According to another embodiment, there is provided a fuel additive concentrate including the polyetheramine of formula (1) and a carrier oil or solvent and optionally one or more performance additives.

In still another embodiment, there is provided a fuel composition including as a fuel additive the polyetheramine of formula (1) and a fuel.

The fuel compositions of the present disclosure may be combusted in any fuel combustion system, including for example, any gasoline vehicle, diesel-electric hybrid vehicle, a gasoline-electric hybrid vehicle, a two-stroke engine, any and all burners or combustion units, including for example, stationary burners (home heating, industrial, boilers, furnaces), waste incinerators, diesel fuel burners, diesel fuel engines (unit injected and common rail), jet engines, homogeneous charge compression ignition engines, automotive diesel engines, gasoline fuel burners, gasoline fuel engines, power plant generators and the like.

In another embodiment, there is provided a method of improving the performance of a fuel combustion system comprising adding the polyetheramine of formula (1) to a fuel to form an additized fuel and combusting the additized fuel in the fuel combustion system.

In yet another embodiment, there is provided a method of controlling deposits and/or improving the efficiency of a fuel combustion system, by adding the polyetheramine of formula (1) into a fuel to form an additized fuel and combusting the fuel in the fuel combustion system.

### DETAILED DESCRIPTION

The present disclosure provides a dialkyl phenol initiated polyetheramine and its use in various applications, in particular, as a fuel additive for use in a fuel. Without being bound by theory, it is believed that the presence of the dialkyl group in the subsequently produced polyetheramine increases the hydrophobicity of the polyetheramine. This increase in hydrophobicity is believed to allow the polyetheramine, when added to a fuel, to be better able to control deposits during combustion of the fuel in a fuel combustion system as compared to the fuel alone or to the fuel in combination with state of the art mono-alkyl phenol initiated polyetheramines. This improvement in the controlling of deposits may lead to a significant reduction in maintenance costs and/or an increase in power and/or an improvement in fuel economy. Moreover, because the hydrophobicity of the polyetheramine is increased by the dialkyl group, the butylene oxide groups normally required in the polyether backbone of state of the art polyetheramines may be partially or fully replaced by propylene oxide groups making the polyetheramines of the present disclosure more cost effective.

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The terms “or” and “and/or”, unless stated otherwise, refer to the listed members individually as well as in any combination. For example, the expression A and/or B refers to A alone, B alone, or to both A and B.

The articles “a” and “an” are used herein to refer to one or to more than one (i.e. to at least one) of the grammatical objects of the article. By way of example, “a polyetheramine” means one polyetheramine or more than one polyetheramine. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment. If the specification states a component or feature “may”, “can”, “could”, or “might” be included or have a characteristic, that particular component or feature is not required to be included or have the characteristic.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “optional” or “optionally” means that the subsequently described event or circumstance may or may not occur, and that the description includes instances where said event or circumstance occurs and instances where it does not.

The term “major amount” is understood to mean an amount greater than or equal to 50 wt. %, for example from about 60 wt. % to about 99.5 wt. %, or from about 70 wt. % to about 99 wt. %, or from about 80 wt. % to about 98 wt. % relative to the total weight of the composition. Moreover, as used herein, the term “minor amount” is understood to mean an amount less than 50 wt. %, for example from about 0.1 wt. % to about 40 wt. %, or from about 1 wt. % to about 30 wt. %, or from about 5 wt. % to about 20 wt. %, relative to the total weight of the composition.

The term “substantially free” refers to a composition in which a particular constituent or moiety is present in an amount that has no material effect on the overall composition. In some embodiments, “substantially free” may refer to a composition in which the particular constituent or moiety is present in the composition in an amount of less than about 5 wt. %, or less than about 4 wt. %, or less than about 3 wt. % or less than about 2 wt. % or less than about 1 wt. %, or less than about 0.5 wt. %, or less than about 0.1 wt. %, or less than about 0.05 wt. %, or even less than about 0.01 wt. % based on the total weight of the composition, or that no amount of that particular constituent or moiety is present in the respective composition.

The term “fuel additive” means an additive that imparts beneficial properties to fuel and/or an engine and related fuel-handling components.

The term “alkyl” refers to a monovalent radical of an alkane. Suitable alkyl groups can have, for example, up to about 30 carbon atoms, or up to 24 carbon atoms, or up to 20 carbon atoms, or up to 16 carbon atoms, or up to 12 carbon atoms, or up to 10 carbon atoms, or up to 8 carbon atoms, or up to 6 carbon atoms, or up to 4 carbon atoms, or up to 3 carbon atoms. In some embodiments, the alkyl group may have, for example, between 1 and 30 carbon atoms, or between 3 and 24 carbon atoms or between 8 and 14 carbon atoms. The alkyl groups may be linear, branched, cyclic, or a combination thereof.

Controlling deposits, deposit control or the like as used herein is intended to cover one or more of: reducing existing deposits (“clean-up”); reducing deposit formation (“keep-clean”); and modifying deposits so as to reduce their negative effects.

According to one embodiment, the present disclosure provides a fuel additive for a fuel comprising a dialkyl phenol initialized polyetheramine compound having a formula (1):

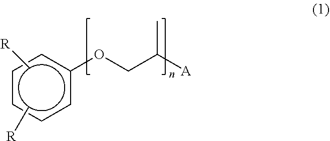

where each R may be the same or different and is an alkyl group having up to 30 carbon atoms, n is an integer from about 2 to about 200, and A is —NH₂ or —NHRₐ, where Rₐ is an alkyl group having up to about 30 carbon atoms.

In one embodiment, each R is the same alkyl group having up to 30 carbon atoms, or having up to 24 carbon atoms or having up to 16 carbon atoms. In another embodiment, each R is a different alkyl group having up to 30 carbon atoms, or having up to 24 carbon atoms, or having up to 16 carbon atoms. In some embodiments, each R is the same alkyl group having 1 to 12 carbon atoms or 2 to 10 carbon atoms. Specific examples of alkyl groups include, but are not limited to, methyl, ethyl, propyl, butyl, heptyl, octyl, nonyl, dodecyl and tridecyl.

In another embodiment, n is an integer from about 3 to about 100 or from about 5 to about 50 or from about 7 to about 25 or from about 8 to about 20, or from about 9 to about 17 or from about 10 to about 15.

In some embodiments, A is NH₂. In other embodiments, A is —NHRₐ where Rₐ is an alkyl group having up to about 24 carbon atoms, or having up to about 20 carbon atoms, or having up to about 12 carbon atoms. In other embodiments, Rₐ is an alkyl group having 1 to about 12 carbon atoms or 2 to about 10 carbon atoms. Examples of alkyl groups include, but are not limited to, methyl, ethyl, propyl, isopropyl, butyl. isobutyl, sec-butylamine, tert-butyl, pentyl, cyclopentyl, hexyl, cyclohexyl, octylamine, decyl, dodecyl and octadecyl.

According to another embodiment, each R is the same alkyl group having 1 to 16 carbon atoms, n is an integer from about 5 to about 50 and A is NH₂. In another embodiment, each R is individually selected from the group consisting of methyl, ethyl, propyl, butyl, heptyl, octyl, nonyl and dodecyl, n is an integer from about 7 to about 25 and A is NH₂, In still another embodiment, each R is the same alkyl group having 8 to 14 carbon atoms, n is an integer from about 8 to about 20 and A is NH₂.

The dialkyl phenol initialized polyetheramine compound having the formula (1) can be prepared by methods known to those skilled in the art. For example, it can be prepared utilizing a dialkyl phenol compound having the formula (2)

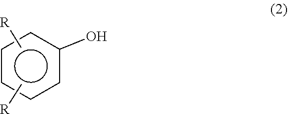

where R is defined above, as an initiator that is first charged to an alkoxylation reaction zone.

After charging, the dialkyl phenol initiator is contacted with propylene oxide in the alkoxylation reaction zone for a period of time sufficient to provide an intermediate polyol.

The amount of propylene oxide which is contacted with the initiator may range from about 2 to about 50 moles, and in some instances from about 10 to about 30 moles, of propylene oxide per mole of initiator. Additionally, the period of time the initiator is contacted with propylene oxide is a period of time sufficient to form the intermediate polyol, and in some instances may range from about 0.5 hours to about 24 hours.

The alkoxylation reaction zone can be a closed reaction vessel with alkoxylation being carried out under elevated temperature and pressure and in the presence of a base catalyst or a double metal cyanide (DMC) catalyst. For example, alkoxylation may be conducted at a temperature ranging from about 50° C. to about 150° C. and at a pressure ranging from about 40 psi to about 100 psi. The base catalyst may be any alkaline compound customarily used for base-catalyzed reactions, for example, an alkali metal hydroxide, such as sodium hydroxide, lithium hydroxide, potassium hydroxide, or cesium hydroxide, or a tertiary amine, such as dimethyl cyclohexylamine or 1,1,3,3-tetramethylguanidine. After alkoxylation, the resulting product may be vacuum stripped to remove any unnecessary components, such as excess unreacted alkylene oxide, water and/or base catalyst, while leaving the resulting intermediate polyol.

The intermediate polyol is then used as a feedstock in a reductive amination step. In some instances, prior to reductive amination, the intermediate polyol is neutralized with acid or a chemical adsorbent, such as for example, oxalic acid or magnesium silicate, and filtered for the removal of insoluble materials. The intermediate polyol is charged to a reductive amination zone where it is brought into contact with a reductive amination catalyst, sometimes referred to as a hydrogenation-dehydrogenation catalyst, and reductively aminated in the presence of hydrogen and ammonia or a primary alkyl amine under reductive amination conditions. Reductive amination conditions may include, for example, a temperature within the range of about 150° C. to about 275° C. and a pressure within the range of about 500 psi to about 5000 psi or with a temperature within the range of about 180° C. to about 220° C. and pressure within the range of about 100 psi to about 2500 psi being used in some embodiments.

In one embodiment, the primary alkyl amine contains 1 nitrogen atom and from about 1 to about 30 carbon atoms, or from about 1 to about 6 carbon atoms, or even from about 1 to about 4 carbon atoms. Examples of primary alkyl amines include, but are not limited to, N-methylamine, N-ethylamine, N-propylamine, N-isopropylamine, N-butylamine, N-isobutylamine, N-sec-butylamine, N-tert-butylamine, N-pentylamine, N-cyclopentylamine, N-hexylamine, N-cyclohexylamine, N-octylamine, N-decylamine, N-dodecylamine, N-octadecylamine and the like.

Any suitable hydrogenation catalyst may be used, such as those described in U.S. Pat. No. 3,654,370, the contents of which are incorporated herein by reference. In some embodiments, the hydrogenation catalyst may comprise one or more of the metals of group VIIIB of the Periodic Table, such as iron, cobalt, nickel, ruthenium, rhodium, palladium, and platinum, mixed with one or more metals of group VIB of the Periodic Table such as chromium, molybdenum or tungsten. A promoter from group IB of the Periodic Table, such as copper, may also be included. As an example, a catalyst may be used comprising from about 60 mole percent to about 85 mole percent of nickel, about 14 mole percent to about 37 mole percent of copper and about 1 mole percent to about 5 mole percent of chromium (as chromia), such as a catalyst of the type disclosed in U.S. Pat. No. 3,152,998. As another example, a catalyst of the type disclosed in U.S. Pat. No. 4,014,933 may be used containing from about 70% by weight to about 95% by weight of a mixture of cobalt and nickel and from about 5% by weight to about 30% by weight of iron. As another example, a catalyst of the type disclosed in U.S. Pat. No. 4,152,353 may be used, comprising nickel, copper and a third component which may be iron, zinc, zirconium or a mixture thereof, for example, a catalyst containing from about 20% by weight to about 49% by weight of nickel, about 36% by weight to about 79% by weight of copper and about 1% by weight to about 15% by weight of iron, zinc, zirconium or a mixture thereof. As still another example, a catalyst of the type described in U.S. Pat. No. 4,766,245 may be used comprising about 60% by weight to about 75% by weight of nickel and about 25% by weight to about 40% by weight of aluminum.

The reductive amination may be conducted on a continuous basis with the intermediate polyol, ammonia or primary alkyl amine and hydrogen being continuously charged to a reactor containing a fixed bed of reductive amination catalyst and with product being continually withdrawn.

The product is suitably depressured so as to recover excess hydrogen and ammonia or primary alkyl amine for recycle and is then fractionated to remove by-product water of reaction to provide the inventive polyetheramine.

During reductive amination, the reductive amination conditions which may also be utilized include the use of from about 4 moles to about 150 moles of ammonia or primary amine per hydroxyl equivalent of intermediate polyol feedstock. Hydrogen may be used in an amount ranging from about 0.5 mole equivalents to about 10 mole equivalents of hydrogen per hydroxyl equivalent of intermediate polyol feedstock. The contact times within the reaction zone, when the reaction is conducted on a batch basis, may be within the range of from about 0.1 hours to about 6 hours or from about 0.15 hours to about 2 hours.

When the reaction is conducted on a continuous basis using catalyst pellets, reaction times may be from about 0.1 grams to about 2 grams of feedstock per hour per cubic centimeter of catalyst and, more preferably, from about 0.3 grams to about 1.6 grams of precursor feedstock per hour per cubic centimeter of catalyst. Also, the reductive amination may be conducted in the presence of about 1 mole to about 200 moles of ammonia or primary alkyl amine per mole of intermediate polyol or from about 4 moles to about 130 moles of ammonia or primary alkyl amine per mole of intermediate polyol. From about 0.1 moles to about 50 moles of hydrogen per mole of intermediate polyol may be employed or from about 1 mole to about 25 moles of hydrogen per mole of intermediate polyol.

The dialkyl phenol initialized polyetheramines of formula (1) are useful in a variety applications, including, but not limited to, as a fuel additive in a fuel composition. Other applications may include, but are not limited to, use as dispersing agent for organic and inorganic pigments, dyestuffs, and color brighteners, as a cement additive, and in oil & gas field applications, such as a corrosion inhibitor, a demulsifier and an acid retarding agent. In still other applications, the polyetheramine of formula (1) may be used in various formulations such as adhesive formulations, agricultural formulations, coatings formulations, electronics formulations, household-industrial-institutional (HI&I) formulations, metal working formulations, paint formulations, plastics formulations, polyurethane formulations, textile formulations, wood-care formulations and skin, sun, oil, hair, cosmetic, and preservative formulations.

Thus, in one embodiment, the polyetheramine of formula (1) may be useful as a fuel additive for a fuel composition. In such embodiments, the fuel composition, which includes the polyetheramine of formula (1) and a fuel, is useful in fueling a fuel combustion system, such as a liquid fuel engine and/or for spark ignited engine. The type of fuel combustion system is not overly limited and includes, but is not limited to, a V engine, an inline engine, an opposed engine, and a rotary engine. The engine may be naturally aspirated, boosted, E-boosted, supercharged, or a turbocharged engine. The engine may be a carbureted or fuel injected gasoline engine. As such, the engine may have a carburetor or injectors (including piezo injectors).

In one embodiment, the engine may be a gasoline direct injection (“GDI”) engine (spray or wall guided, or combinations thereof), a portable fuel injection (“PFI”) engine, a homogeneous charge compression ignition (“HCCI”) engine, stoichiometric burn or lean burn engine, spark controlled compression ignition (“SPCCI”) engine, variable compression, Miller cycle or Atkinson cycle engine, or a combination thereof, such as an engine that contains both GDI and PFI injectors in the same engine. Suitable GDI/PFI engines includes 2-stroke or 4-stroke engines fueled with gasoline, a mixed gasoline/alcohol or any of the fuel compositions known to those skilled in the art.

In yet other embodiments, any of the above engines may be equipped with a catalyst or device for treating exhaust emissions, such as reducing NOₓ. In other embodiments, the engine may be a flexible-fuel engine able to operate on more than one fuel type, typically, gasoline and ethanol or gasoline and methanol. In yet other embodiments, any of the above engine types may be in a hybrid vehicle that also includes an electric motor.

In some embodiments, the fuel composition may include the polyetheramine of formula (1) in a minor amount and the fuel in a major amount. In still further embodiments, the polyetheramine of formula (1) may be added directly to the fuel composition or it may be added to the fuel composition as a component of a fuel additive concentrate which includes some amount of fuel, carrier oil or a solvent and optionally one or more performance additives.

Fuels suitable for use are not overly limited and may include, for example, a gasoline as defined by ASTM specification D4814, a diesel fuel, as defined by ASTM specification D975, a biodiesel fuel, or any combination thereof. The fuel may further be leaded or unleaded motor and aviation gasolines and so-called reformulated gasolines which contain both hydrocarbons of the gasoline boiling range and fuel-soluble oxygenated blending agents, such as alcohols, ethers and other suitable oxygen-containing organic compounds. Suitable oxygenates include, for example, methanol, ethanol, isopropanol, t-butanol, mixed C₁ to C₅ alcohols, methyl tertiary butyl ether, tertiary amyl methyl ether, ethyl tertiary butyl ether, mixed ethers, trans-esterified oils and/or fats from plants and animals such as rapeseed methyl ester and soybean methyl ester, and nitromethane. Oxygenates, when used, will normally be present in the fuel in an amount below about 25% by volume, for example in an amount that provides an oxygen content in the overall fuel in the range of about 0.5 to about 5% by volume.

The fuel for use can also include heavier fuel oils, such as number 5 and number 6 fuel oils, which are also referred to as residual fuel oils, heavy fuel oils, and/or furnace fuel oils. Such fuels may be used alone or mixed with other, typically lighter, fuels to form mixtures with lower viscosities. Bunker fuels are also included, which are generally used in marine engines. These types of fuels have high viscosities and may be solids at ambient conditions, but are liquid when heated and supplied to the engine it is fueling. Other fuels known as alternative fuels may also be used. These fuels will include fuels such as 100% ethanol, hydrated ethanol, 70%-85% ethanol known as “E85”.

The fuel is generally present in the fuel composition in a major amount which, in some embodiments, may be greater than about 90 wt. %, or greater than about 95 wt. %, or in other embodiments greater than about 97 wt. %, or greater than about 99.5 wt. %, or greater than about 99.9 wt. %, or even greater than about 99.99 wt. %, based on the total weight of the fuel composition.

The polyetheramine of formula (1) is generally present in the fuel composition in a minor amount that is generally less than about 10 wt. %, or less than about 1 wt. %, or less than about 0.5 wt. % or even less than about 0.1 wt. % (1000 ppmw) (parts per million by weight), or less than about 0.07 wt. % (700 ppmw), or less than about 0.05 wt. % (500 ppmw), or less than about 0.04 wt. % (400 ppmw), or less than about 0.03 wt. % (300 ppmw), or less than about 0.025 wt. % (250 ppmw), or less than about 0.02 wt. % (200 ppmw), or less than about 0.01 wt. % (100 ppmw), based on the total weight of the fuel composition.

In other embodiments, the polyetheramine of formula (1) present in the fuel composition may be at least about 0.1 ppmw (parts per million weight), based on the total weight of the fuel composition. In another embodiment, the amount of the polyetheramine of formula (1) present in the fuel composition of the present disclosure may be at least about 1 ppmw, or at least about 5 ppmw, or at least about 10 ppmw, or at least about 20 ppmw, or at least about 30 ppmw, or at least about 40 ppmw, or at least about 50 ppmw, or at least about 60 ppmw, or at least about 70 ppmw, or at least about 80 ppmw, or at least about 90 ppmw, or at least about 100 ppmw, or at least about 1000 ppmw, based on the total weight of the fuel composition.

In one embodiment, the polyetheramine of formula (1) is part of a fuel additive concentrate. Such fuel additive concentrates containing the polyetheramine of formula (1) are compositions that may optionally contain one or more performance additives as well as some amount of fuel, a carrier oil, or a solvent of some type. The fuel additive concentrate can then be added to other compositions as a convenient way to handle and deliver the additives, resulting in the final fuel composition described above. The fuel additive concentrate may, in general, contain the polyetheramine of the formula (1) in an amount of about 0.1 wt. % to about 99 wt. %, or about 0.5 wt. % to about 80 wt. %, or about 0.75 wt. % to about 70 wt. %, or about 1 wt. % to about 60 wt. %, or about 5 wt. % to about 50 wt. % or about 10 wt. % to about 40 wt. %, based on the total weight of the fuel additive concentrate.

The additional performance additives can include, but are not limited to: an antioxidant such as a hindered phenol or derivative thereof and/or a diarylamine or derivative thereof; a corrosion inhibitor; and/or a detergent/dispersant additive, such as an additional polyetheramine or nitrogen containing detergent, including but not limited to PIB amine detergents/dispersants, succinimide detergents/dispersants, and other quaternary salt detergents/dispersants including quaternary ammonium imide salts, that is a detergent containing an imide group and a quatemary ammonium salt.

Other additional performance additives may also include: a cold flow improver such as an esterified copolymer of maleic anhydride and styrene and/or a copolymer of ethylene and vinyl acetate; a foam inhibitor and/or antifoam agent such as a silicone fluid; a demulsifier such as a polyalkoxylated alcohol; a lubricity agent such as a fatty carboxylic acid; a metal deactivator such as an aromatic triazole or derivative thereof, including but not limited to benzotriazole; and/or a valve seat recession additive such as an alkali metal sulfosuccinate salt.

The additional performance additives may also include a biocide; an antistatic agent, a deicer, a fluidizer such as a mineral oil and/or poly(alpha-olefin) and/or polyether, and a combustion improver such as an octane or cetane improver.

The additional performance additives can each be added directly to the fuel additive concentrate and/or the fuel composition, but they are generally mixed with the polyetheramine of formula (1) to form the fuel additive concentrate, which is then mixed with fuel to result in a fuel composition.

The fuel additive concentrate may also include a carrier oil, such as a mineral carrier oil or a synthetic carrier oil. Suitable mineral carrier oils are the fractions obtained in crude oil processing, such as brightstock or base oils having viscosities, for example, from the SN 500 to 2000 class, but also aromatic hydrocarbons, paraffinic hydrocarbons and alkoxyalkanols. Likewise useful is a fraction which is obtained in the refining of mineral oil and is known as “hydrocrack oil” (vacuum distillate cut having a boiling range from about 360° to 500° C., obtainable from natural mineral oil which has been catalytically hydrogenated and isomerized under high pressure and also deparaffinized). Likewise suitable are mixtures of the abovementioned mineral carrier oils. Examples of suitable synthetic carrier oils are polyolefins (polyalphaolefins or polyintemalolefins), (poly)esters, (poly)alkoxylates, polyethers, alkylphenol-started polyethers and carboxylic esters of long-chain alkanols.

In some embodiments, the carrier oil may be present in the fuel additive concentrate in an amount of from about 0.5 wt. % to about 50 wt. % or from about 2 wt. % to about 40 wt. % or from about 3 wt. % to about to 30 wt. %, based on the total weight of the fuel additive concentrate.

The fuel additive concentrate may also include a solvent. The solvent provides for a homogeneous fuel additive concentrate and for facilitating the transfer and handling of the fuel additive concentrate. In some embodiments, the solvent is an aliphatic hydrocarbon, aromatic hydrocarbon or a mixture thereof.

Aliphatic hydrocarbons include various naphtha and kerosene boiling point fractions that have a majority of aliphatic components. Aromatic hydrocarbons include benzene, toluene, xylenes and various naphtha and kerosene boiling point fractions that have a majority of aromatic components. In one embodiment, the solvent can be present in the fuel additive concentrate at about 1 wt. % to about 90 wt. %, in another embodiment at about 25 wt. % to about 85 wt. %, and yet in another embodiment, at about 40 wt. % to about 80 wt. %, based on the total weight of the fuel additive concentrate.

The polyetheramine of formula (1) alone, or as part of a fuel additive concentrate may be added to the fuel at any convenient place in the supply chain. For example, the polyetheramine of formula (1) or fuel additive concentrate may be added to the fuel at the refinery, at a distribution terminal or after the fuel has left the distribution terminal. If added to the fuel after it has left the distribution terminal, this is termed an aftermarket application. Aftermarket applications include such circumstances as adding the polyetheramine of formula (1) or fuel additive concentrate to the fuel in a delivery tanker, directly to a customer's bulk storage tank, or directly to an end user's vehicle tank. Aftermarket applications may include supplying the polyetheramine of formula (1) or fuel additive concentrate in small bottles suitable for direct addition to storage tanks or vehicle tanks.

In another embodiment, the present disclosure provides a method of controlling deposits in an engine comprising adding the polyetheramine of formula (1) and optionally a carrier oil, solvent or performance additive into a fuel to be combusted to form an additized fuel and combusting the additized fuel in the engine.

In another embodiment, the present disclosure provides a method of improving the efficiency of an engine comprising adding the polyetheramine of formula (1) and optionally a carrier oil, solvent or performance additive into the fuel to be combusted to form an additized fuel and combusting the additized fuel in the engine.

In yet another embodiment, the present disclosure provides a method of improving the performance of an engine comprising adding the polyetheramine of formula (1) and optionally a carrier oil, solvent or performance additive into a gasoline to be combusted to form an additized fuel and combusting the additized fuel in the engine wherein the improved performance is one or more of: improved fuel economy; reduced maintenance; less frequent overhaul or replacement of injectors; improved drivability; improved power; and improved acceleration.

### EXAMPLES

### Example 1. Synthesis of a Dialkyl Initiated Polyetheramine According to the Present Disclosure

Four (4) pounds of dinonylphenol were mixed with 34 grams of 45% KOH solution in a reactor. Water was removed from the mixture by applying heat to mixture at 120° C. and 9.31 pounds of propylene oxide (PO) was added to the reactor to alkoxylate dinonylphenol. After the alkoxylation reaction was completed, 75 grams of Magnesol were added to remove potassium ions from the mixture. The alkoxylated intermediate was filtered then reacted with ammonia and hydrogen in a fixed bed reactor in the presence of a metal catalyst. Ammonia was then stripped off to produce a transparent and clear liquid polyetheramine product. The polyetheramine product was found to have a flashing point of 240° C., a total amine number of about 0.899 meq/g and a total acylatable value of about 0.9213 meq/g. Based on these properties, the dialkyl phenol conversion was calculated to be around 97.6% and the average molecular weight of the polyetheramine product was found to be 1085.

### Example 2. Synthesis of Dialkyl Initialized Polyetheramine According to the Present Disclosure

Four (4) pounds of dinonylphenol were mixed with 50.4 g 45% KOH solution in a reactor. After water was removed from the mixture while the mixture was heated at 120° C., 16 pounds of propylene oxide (PO) were added to the reactor to alkoxylate dinonylphenol. After the alkoxylation reaction was completed, 113.5 grams of Magnesol were added to remove potassium ions from the mixture. The alkoxylated intermediate was filtered and then reacted with ammonia and hydrogen in a fixed bed reactor in the presence of a metal catalyst. Ammonia was stripped off to produce a transparent clear liquid polyetheramine product. The polyetheramine product was found to have a flashing point of 240° C., a total amine number of about 0.671 meq/g and a total acylatables value of about 0.7058 meq/g. Based on these properties, the dialkyl phenol polyol conversion was found to be about 95.1% and the average molecular weight of polyetheramine product was found to be 1417.

### Example 3. Evaluation of the Inventive Polyetheramines as Gasoline Deposit Control Agents

This evaluation was performed on a L-2 self-controlled gasoline engine intake valve sediment simulation test machine which simulates the tendency of sediment (deposit) generation for a gasoline engine intake valve. Jeffamine® FL-1000 polyetheramine was used as the comparative polyetheramine since it is a highly popular polyetheramine for controlling deposits control. It has the following structure.

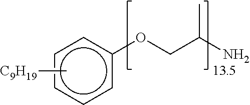

RON 92 gasoline from a gasoline station was used as the fuel. The polyetheramine was added to the fuel in a dosage of 200 ppm and 600 ppm for a “keep clean” test and a “clean up” test, respectively. The results are shown in the following Table 1.

TABLE 1

| | Comparative | | |
|---|---|---|---|
| Product | Polyetheramine | Example 1 | Example 2 |
| Weight of | 1.0 | 0.7 | 0.5 |
| deposit in | | | |
| “keep clean” | | | |
| test (mg) | | | |
| Cleaning up | 27.06 | 36.0 | 41.66 |
| rate in | | | |
| “Clean up” | | | |
| test (%) | | | |

As shown in Table 1 above, the inventive dialkyl initiated polyetheramines from Example 1 and Example 2 were significantly better at controlling deposits than the mono-alkyl initiated polyetheramine in both the “keep clean” test and the “clean up” test.

While the foregoing is directed to embodiments of the present disclosure, other and further embodiments of the disclosure may be devised without departing from the basic scope thereof, and the scope thereof is determined by the claims that follow.

1. A fuel additive for a fuel comprising a polyetheramine compound having a formula (1) 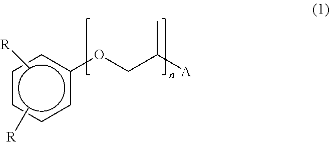
wherein each R may be the same or different and is an alkyl group having up to 30 carbon atoms, n is an integer from about 2 to about 200, and A is —NH₂ or —NHRₐ, wherein Rₐ is an alkyl group having up to about 30 carbon atoms.

2. The fuel additive of claim 1, wherein each R is the same alkyl group having 1 to 12 carbon atoms.

3. The fuel additive of claim 2, wherein R is selected from methyl, ethyl, propyl, butyl, heptyl, octyl, nonyl and dodecyl.

4. The fuel additive of claim 1, wherein A is NH₂.

5. The fuel additive of claim 1, wherein n is an integer from about 5 to about 50.

6. A process for producing a polyetheramine compound comprising charging a dialkyl phenol compound having a formula (2) 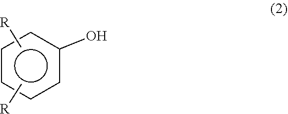
wherein each R may be the same or different and is an alkyl group having up to 30 carbon atoms to an alkoxylation reaction zone, contacting the dialkyl phenol with propylene oxide in the alkoxylation reaction zone for a period of time to provide an intermediate polyol, charging the intermediate polyol to a reductive amination zone, and contacting the intermediate polyol in the reductive amination zone with a reductive amination catalyst in the presence of hydrogen and ammonia or a primary alkyl amine.

7. The process according to claim 6, wherein the intermediate polyol is contacted with the reductive amination catalyst in the presence of hydrogen and ammonia.

8. A fuel additive concentrate comprising the fuel additive of claim 1, a carrier oil or a solvent and optionally one or more performance additives.

9. The fuel additive concentrate of claim 8, wherein the carrier oil comprises a mineral carrier oil or a synthetic carrier oil.

10. The fuel additive concentrate of claim 8, wherein the solvent comprises an aliphatic hydrocarbon, aromatic hydrocarbon or a mixture thereof.

11. A fuel composition comprising the fuel additive of claim 1 in a minor amount and a fuel in a major amount.

12. The fuel composition of claim 11, wherein the fuel comprises gasoline.

13. The fuel composition of claim 11, wherein the fuel additive is added to the fuel after the fuel has left a distribution terminal.

14. A method of controlling deposits in an engine comprising adding the fuel additive of claim 1 and optionally a carrier oil, a solvent or one or more performance additives into a fuel to be combusted to form an additized fuel and combusting the additized fuel in the engine.

15. The method of claim 14, wherein the fuel comprises gasoline and engine is a portable fuel injection (PFI) or gasoline direct injection (GDI) engine.

16. A method of improving the performance of an engine comprising adding the fuel additive of claim 1 and optionally a carrier oil, solvent and one or more performance additives into a gasoline to be combusted to form an additized fuel and combusting the additized fuel in the engine wherein the improved performance is one or more of: improved fuel economy; reduced maintenance; less frequent overhaul or replacement of injectors; improved drivability; improved power; or improved acceleration.
